(19) United States
(12) Patent Application Publication
(10) Pub. No.: US 2023/0229968 A1
(43) Pub. Date: Jul. 20, 2023

(54) APPARATUS, SYSTEM, AND COMPUTER-IMPLEMENTED METHOD FOR OPERATING A TECHNICAL SYSTEM

(71) Applicant: Robert Bosch GmbH, Stuttgart (DE)

(72) Inventors: Matthias Bitzer, Stuttgart (DE); Christoph Zimmer, Korntal (DE); Mona Meister, Renningen (DE)

(21) Appl. No.: 18/152,716

(22) Filed: Jan. 10, 2023

(30) Foreign Application Priority Data
Jan. 14, 2022 (DE) 10 2022 200 418.3

(51) Int. Cl. G06N 20/00

(52) U.S. Cl. CPC G06N 20/00

(57) ABSTRACT

Apparatus, system and computer-implemented method of operating a technical system. A first variable of the technical system is mapped onto a prediction for a second variable of the technical system using a Gaussian process, and the technical system is operated depending on the prediction. The Gaussian process, depending on a sum of a first Gaussian process, weighted with a first weight function, is determined with a second Gaussian process. The first Gaussian process maps the first variable based onto a first prediction of the second variable, and the second Gaussian process maps the first variable onto a second prediction for the second variable. Sub-domains of a domain and/or a value range of the Gaussian process are determined depending on a numerical representation of a binary tree with leaves and nodes.

### CROSS REFERENCE

The present application claims the benefit under 35 U.S.C. § 119 of German Patent Application No. DE 10 2022 200 418.3 filed on Jan. 14, 2022, which is expressly incorporated herein by reference in its entirety.

### FIELD

The present invention relates to an apparatus, system, and computer-implemented method for operating a technical system.

### BACKGROUND INFORMATION

Gaussian processes may be employed for regression to operate technical systems. Machine learning methods in which a Gaussian process for regression is learned, require large amounts of data for learning and require many computing resources, e.g., computing time or computing power.

### SUMMARY

According to an example embodiment of the present invention, a domain from which an input variable of a Gaussian process is taken is divided into sub-domains and connected to an information-based selection of input variables from the area. By employing a covariance that can be differentiated via its parameters, gradient-based methods can be used for determining the parameters. Overall, due to the learning rate achieved for the regression with the Gaussian process on the one hand, with unchanged computing power, the computing time required until the

Gaussian process can be used to operate the technical system is reduced. On the other hand, regression and machine learning are possible with unaltered computing time with lower computing power. Thus, fewer data are used, i.e., the technical system that is to be mapped must be evaluated at fewer points.

According to an example embodiment of the present invention, a computer-implemented method of operating a technical system provides that a first variable of the technical system is mapped to a prediction for a second variable of the technical system using a Gaussian process, and that the technical system is operated, depending on the prediction or depending on a value of the first variable, for which a measure of information gain defined as a function of the prediction indicates a greater information gain than for another value of the first variable, wherein the Gaussian process, depending on a sum of a first

Gaussian process, weighted with a first weight function, is determined with a second Gaussian process, wherein the first Gaussian process is designed to map the first variable onto a first prediction for the second variable, and the second Gaussian process is designed to map the first variable onto a second prediction for the second variable, wherein sub-domains of a domain and/or a value range of the Gaussian process are determined depending on a numerical representation of a binary tree with leaves and nodes, wherein a first leaf of the leaves is assigned to the first Gaussian process, wherein each node is assigned a vector representing one of the sub-domains, wherein the nodes are each assigned a first weight that depends on the first variable and the vector assigned to the respective node, wherein the first weight function is determined depending on the first weights of the nodes, in the first, in particular left, subtree of which the first leaf is located and/or wherein the nodes are each assigned a second weight, which depends on the first variable and the vector that is assigned to the respective node, wherein the first weight function is determined depending on the second weights of the nodes, in the second, in particular right, subtree of which the first leaf is located. This weight function encodes a relevance of the first Gaussian process to the sub-domains. This improves the overall operation of the technical system as a function of the prediction of the Gaussian process.

Preferably, according to an example embodiment of the present invention, the second Gaussian process is weighted with a second weight function, wherein the second Gaussian process is assigned a second leaf of the leaves that is different from the first leaf, wherein the second weight function is determined depending on the first weights of the nodes, in the first, in particular left, subtree of which the second of the leaves is located and/or wherein the second weight function is determined depending on the second weights of the nodes, in the second, in particular right, subtree of which the second leaf is located. This weight function encodes a relevance of the second Gaussian process for the sub-domains. This further improves the overall operation of the technical system as a function of the prediction of the Gaussian process.

Preferably, per node, the second weight is determined depending on the first weight assigned to this node. Thus, the more relevant sub-domains and the less relevant sub-domains are weighted with weights representing a ratio of relevance. This further improves the overall operation of the technical system as a function of the prediction of the Gaussian process.

By the weight function and the partition of space generated thereby for the first variable, portions of the domain of the first variable are identified that have a high information content. Data are then preferably taken from these portions.

It may be provided that, per node, a first value is assigned to a pair of the first weight function and the first weight assigned to this node, if the first weight function is located in the first, in particular left, subtree of the node, and wherein the first weight function is determined depending on a computing operation with this first weight and the first value, and/or, per node, a second value is assigned to a pair of the first weight function and the first weight assigned to this node, if the first weight function is located in the second, in particular right, subtree of the node, and wherein the first weight function is determined depending on a computing operation with this first weight and the second value.

It may be provided that, per node, a first value is assigned to a pair of the first weight function and the second weight assigned to this node, if the first weight function is located in the second, in particular right, subtree of the node, and wherein the first weight function is determined depending on a computing operation with this first weight and the first value, and/or, per node, a second value is assigned to a pair of the first weight function and the second weight assigned to this node, if the first weight function is located in the first, in particular left, subtree of the node, and wherein the first weight function is determined depending on a computing operation with this first weight and the second value.

Regardless of whether or not the Gaussian process is centered, it may be provided that, in order to determine the sum, a first product of the first weight function is determined with an, in particular stationary, first covariance of the first Gaussian process, a second product of the second weight function is determined with an, in particular stationary, second covariance of the second Gaussian process and the sum is determined depending on the result of an addition of the first product and the second product.

According to an example embodiment of the present invention, it may be provided that the Gaussian process is defined by parameters that define a mean value dependent on the first variable and a covariance dependent on the first variable, wherein a first data set is provided, in which a value of the second variable is respectively assigned to a value of the first variable, wherein at least one of the parameters of the Gaussian process is determined depending on the values from the first data set. This determines the Gaussian process in active machine learning.

According to an example embodiment of the present invention, preferably, the measure of the information gain is defined as a function of the Gaussian process, the parameter and the first data set, wherein the value of the first variable is determined, for which the measure is greater, as the measure of the other value of the first variable, wherein a value of the second variable is determined with the technical system or with a model of the technical system, wherein a second data set is determined, in which the thus determined value of the first variable and the thus determined value of the second variable are assigned to each other and wherein at least one of the parameters of the Gaussian process is determined depending on the values from the second data set. The Gaussian process is thereby trained at those locations where little information is yet available. Learning is thus very efficient.

In one embodiment of the present invention, the measure of the information gain is defined depending on the first weight function and the second weight function such that the measure of the information gain has a higher value where the weight function of the Gaussian process which has the higher individual information content is higher. In particular, the weight functions of the first and second Gaussian process described above affect the measure of information to the extent that the measure of information has a higher value where the weight function of the Gaussian process which has the higher individual information content is higher. This achieves the result that the first variable is increasingly selected where the information content is high with respect to the second variable. This makes learning even more efficient.

In one application of the present invention, the first variable is a target variable for an actuator of the technical system or a target variable for an actuator of the technical system is determined depending on the first variable, wherein the technical system is a computer controlled machine, in particular a robot, preferably a vehicle, a household appliance, a tool powered electrically, pneumatically, hydraulically or by an internal combustion engine, a fabrication machine, a personal assistance system or a locking system.

Preferably, according to an example embodiment of the persent invention, the prediction for the second variable identifies data or data are selected depending on the prediction for the second variable, wherein a message is sent from the technical system to a device that is arranged in particular at a distance from the technical system which includes an identification of the data or which instructs the device to collect or determine the data and/or transfer the data. This affects a type or a quantity of the data.

According to an example embodiment of the present invention, it may be provided that the device is a test bench, in particular for a motor, wherein the data comprise an output variable of the test bench, and an instruction for the test bench is sent from the technical system to the test bench instructing the test bench to capture the output variable of the test bench, in particular with a sensor.

According to an example embodiment of the present invention, it may be provided that the device is a computing device, in particular for computer-aided simulation of fluid dynamics, wherein the data comprise a starting variable of the simulation and an instruction for the simulation is sent by the technical system to the computing device, which instructs the computing device to determine the starting variable of the simulation by the simulation, in particular depending on an input variable identified or specified in the instruction.

According to an example embodiment of the present invention, an apparatus for operating a technical system provides that the apparatus comprises at least one processor and at least one memory configured to perform at least a part of the method.

According to an example embodiment of the present invention, it may be provided that a system includes the apparatus and an actuator configured to operate the system depending on the prediction.

According to an example embodiment of the present invention, it may be provided that a system comprises the apparatus and an interface configured to send the message from the system to an apparatus arranged in particular at a distance from the system.

Further advantageous embodiments of the present invention may be gathered from the following description and the figures.

### BRIEF DESCRIPTION OF THE DRAWINGS

FIG. 1 shows a schematic illustration of an apparatus for operating a technical system, according to an example embodiment of the present invention.

FIG. 2 shows steps in a method for operating the technical system, according to an example embodiment of the present invention.

FIG. 3 shows a schematic illustration of a first embodiment of the technical system, according to the present invention.

FIG. 4 shows steps in a method for operating the first embodiment, according to the present invention.

FIG. 5 shows a schematic illustration of a second embodiment of the technical system, according to the present invention.

FIG. 6 shows steps in a method for operating the second embodiment, according to the present invention.

### DETAILED DESCRIPTION OF EXAMPLE EMBODIMENTS

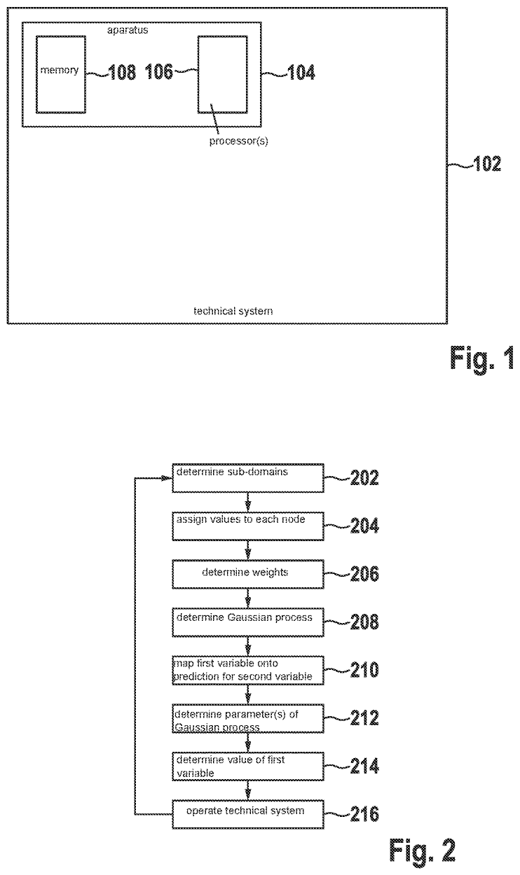

FIG. 1 shows a technical system 102. The technical system 102 includes an apparatus 104 for operating the technical system 102 or is connected to the latter at least temporarily for communication.

The apparatus 104 includes at least one processor 106 and at least one memory 108 configured to perform at least a part of a method described below.

The apparatus 104 is configured to map a first variable x of the technical system 102 using a Gaussian process f˜GP(μ(x), k(x, x′)) onto a prediction f(x) for a second variable y of the technical system 102 and to operate the technical system 102 as a function of the prediction f(x).

For example, the at least one memory 108 stores computer-readable instructions that, when executed by the at least one processor, implement the method. In the example, the Gaussian process f˜GP(μ(x), k(x, x′)) is stored there. In the example, a plurality of further Gaussian processes fᵢ are stored there.

In the example, the Gaussian process f˜GP(μ(x), k(x, x′)) comprises a mean function μ(x) and a covariance

$$k ( x , {x}^{′} ) = {\sum }_{j = 1}^{J} {λ}_{j} ( x ) {λ}_{j} ( {x}^{′} ) {k}_{j} ( x , {x}^{′} )$$

with a weight function dependent on the first variable x

$${λ}_{j} ( x ) = {\prod }_{i = 1}^{M} {σ ( {w}_{i}^{T} \tilde{x} )}^{{ϑ}_{L} ( j , i )} ( 1 - {σ ( {w}_{i}^{T} \tilde{x} )}^{{ϑ}_{R} ( j , i )} )$$

which weights the different sub-domains of a domain of the variable x differently, wherein \tilde{x}=(1, x)^{T}∈ [symbol] ^{d+1} and wherein d is a dimension of the domain.

The functions ϑ_{L}(j, i) and ϑ_{R}(j, i), in the example, encode to which sub-domain of the domain the weight function λⱼ(x) assigns a first weight σ(wᵢ^{T}\tilde{x}) and to which sub-domain the weight function λⱼ(x) a second weight 1−σ(wᵢ^{T}\tilde{x}).

In the example, the first weight σ(wᵢ^{T}\tilde{x}) has a value onto which a sigmoid function σ dependent on the first variable x maps a product of a transpose wᵢ^{T} of a vector wᵢ, representing one of the sub-domains, with the first variable x.

In the example, the second weight 1−σ(wᵢ^{T}\tilde{x}) is defined as a function of the first weight σ(wᵢ^{T}\tilde{x}). In the example, the second weight 1−σ(wᵢ^{T}\tilde{x}) is defined by a difference of the first weight σ(wᵢ^{T}\tilde{x}) with respect to one.

In FIG. 2, steps of the method of operating the technical system 102 are shown.

It may be provided to use the method to train the Gaussian process f˜GP(μ(x), k(x, y)), wherein its parameters γ or a part thereof are determined. In the example, the method for a Gaussian process

$$f ( x ) = {\sum }_{j = 1}^{J} {λ}_{j} ( x ) {f}_{j} ( x )$$

is described, which is determined as a weighted sum of a plurality J of Gaussian processes fⱼ(x) depending on the first variable x.

An a priori probability distribution is provided for the parameters γ. In the example, the parameters γ are determined using a method of probabilistic inference, e.g. a hybrid Monte Carlo algorithm.

The method is described below for a unit square X⊂[0, 1]^{d} as a domain with a dimension d. The method is applicable to other domains. In the unit square X⊂[0, 1]^{d}, hyperplanes wᵢ=αᵢ\tilde{w}ᵢ are provided, wherein αᵢ∈ [symbol] and \tilde{w}ᵢ∈ [symbol] ^{d+1} having a normal distribution N and a gamma distribution Gamma are provided as follows:

\tilde{w}ᵢ˜N(0, I), αᵢ˜Gamma(α, β)

Thus, depending on parameters α/β an a priori probability distribution wᵢ|αᵢ˜N(0, αᵢ²I) is defined that makes weak assumptions about the hyperplanes and affects the gradient of the sigmoid function σ. The sub-domains overlap in this example.

In the example, the weight function λⱼ: X→[0, 1] maps the domain to values in an interval between 0 and 1. In the example, a sum of the weights is one: Σⱼ₋₁^{J}λⱼ(x)=1. The weight functions λⱼ, j−1, . . . , J indicate per Gaussian process fⱼ(x) how these contribute to the modeled Gaussian process f(x).

In the example, the covariance k(x,x′) of the modeled Gaussian process f(x) is determined as covariances kⱼ(x,x′) of these respective Gaussian processes fⱼ(x) weighted with the sum of the respective weight function λⱼ(x):

$$k ( x , {x}^{′} ) = {\sum }_{j = 1}^{J} {λ}_{j} ( x ) {λ}_{j} ( {x}^{′} ) {k}_{j} ( x , {x}^{′} )$$

In the example, the weight function λⱼ(x) in a sub-domain is assigned a value close to one when the covariance kⱼ(x,x′) weighted with this weight function λⱼ(x) describes the covariance k(x,x′) of the modeled Gaussian process f(x) in this sub-domain.

It may be provided that sub-domains for the domain are determined in the method.

In the example, the sub-domains are determined along a binary tree T having M:=J−1 nodes Nᵢ and J leaves. Each node Nᵢ, i=1, . . . , M in the example is [assigned] one of the vectors wᵢ∈ [symbol] ^{d+1}. A respective hyperplane Hᵢ={x∈ [symbol] ^{d}|wᵢ^{T}\tilde{x}=0}is defined as a function of the variable x and a respective vector wᵢ and is respectively assigned to one of the nodes Nᵢ. In the example, each leaf represents a Gaussian process fᵢ(x) from the plurality J of Gaussian processes. Each of the nodes Nᵢ subdivides the input square through the hyperplane Hᵢ assigned to this node Nᵢ. In the example, the first weight σ(wᵢ^{T}\tilde{x}) is assigned to a first, in particular left, subtree of the node Nᵢ. It may be provided that the second weight 1−σ(wᵢ^{T}\tilde{x}) is assigned to a second, in particular right, subtree of the node Nᵢ. In this example, the first subtree is the left subtree of the node Nᵢ and the second subtree is the right subtree of the node Nᵢ. The assignment may also be defined the other way around, i.e., the first subtree is the right subtree and the left subtree is the second subtree, wherein the first and second weights are swapped.

In the example, the respective weight functions λⱼ(x), j=1, . . . , J are determined by multiplying the weights along a respective path from the nodes Nᵢ to the leaf representing the respective Gaussian process fᵢ(x):

$${λ}_{j} ( x ) = {\prod }_{i = 1}^{M} {σ ( {w}_{i}^{T} \tilde{x} )}^{{ϑ}_{L} ( j , i )} ( 1 - {σ ( {w}_{i}^{T} \tilde{x} )}^{{ϑ}_{R} ( j , i )} )$$

wherein ϑ_{L}(j, i), ϑ_{R}(j, i): {1, . . . , J}×{1, . . . M}→{0, 1}encode the tree structure:

$${ϑ}_{L} ( j , i ) = \{ \begin{matrix}1 & if {f}_{j} in the left subtree of the node {N}_{i} \\ 0 & else\end{matrix}$$

$${ϑ}_{R} ( j , i ) = \{ \begin{matrix}1 & if {f}_{j} in the right subtree of the node {N}_{i} \\ 0 & else\end{matrix}$$

In the example, a set A₁, which is defined by the domain X X=: A₁, is subdivided, starting from a root node N₁ of the tree, into subsets Aᵢ, which respectively define one sub-domain. For example, a first hyperplane H₁, which is assigned to the root node N₁, is subdivided into two subsets: A₂:={x∈A₁w|₁^{T}\tilde{x}>0} and A₃:={x∈A₁|w₁^{T}\tilde{x}<0}. In another layer, e.g. at the node Nᵢ, a subset Aᵢ is subdivided again into its subsets {x∈Aᵢ|wᵢ^{T}\tilde{x}>0} and {x∈Aᵢ|wᵢ^{T}\tilde{x}<0}. The sigmoid function a softens the weighting. The subdivision into sub-domains is dependent on a size of the tree. A larger tree results in a finer subdivision into sub-domains than a smaller tree.

In the example, one radial basis function kernel, RBF kernel, is respectively provided as the covariance for the plurality J of the Gaussian processes fⱼ(x). Other kernels are also possible. The Gaussian processes fⱼ(x) have respective parameters θⱼ.

For each parameter in the respective parameter θⱼ, a gamma distribution is provided in the example. The parameters in the respective parameter in θⱼ are dependent on the concrete stationary kernel. An exponential distribution with parameter λ is provided for the sigmoid function σ.

The parameters γ include the parameters γ={\tilde{w}ᵢ, αᵢ, θⱼ, σ|i=1, . . . , M, j=1, . . . , J} in the example.

The hybrid Monte Carlo algorithm is executed in the example, by which there are n draws from a posteriori probability distribution for these parameters γ, wherein with a respective data set D, depending on the respective first variable x*, an estimate f* is determined as a marginal distribution

$$p ( {f}^{*} \vert {x}^{*} , D ) = \int p ( {f}^{*} \vert {x}^{*} , γ , D ) p ( γ \vert D ) d γ \approx \frac{1}{n} {\sum }_{{γ}_{i} \sim p ( γ \vert D )} p ( {f}^{*} \vert {x}^{*} , {γ}_{i} D ) .$$

In the example, starting from an initial data set Dₒ, an oracle f→ [symbol] is determined at a data point xₜ, a noisy observation yₜ=f(xₜ)+εₜ with a normally distributed noise εₜ˜N(0, σ²). The following data sets Dₜ=Dₜ₋₁u{xₜ, yₜ} are determined sequentially in the example. In the example, the following data sets Dₜ are determined with an acquisition function depending on the Gaussian process f, the parameters γ and the current data set Dₜ₋₁:

a(x|Dₜ₋₁)=I(y; f, γ|Dₜ₋₁, x) =H(y|Dₜ₋₁, x)−E_{p(γ|D}_{_{t−1}}₎E_{p(γ, D}_{_{t−1}}_{, x)}[H(y|f, Dₜ₋₁, γ, x)]∝H(y|Dₜ₋₁, x)

wherein the right term H(y|f, Dₜ₋₁, γ, x)=log(σ\sqrt{2πe}) of the difference is independent of x. To evaluate the acquisition function, an entropy E of the marginal distribution p is approximated, e.g. by

Gaussian quadrature. In the example, the acquisition function includes a measure I(y; f, γ|Dₜ₋₁, x) for an information gain.

A value xₜ of the first variable x is determined in the example as follows:

argmax_{x∈X}I(y; f, γ|D_{t, x})

For example, a grid search, random search, or gradient-based search is performed.

To the extent that the parameters γ of the covariance are already known or determined using a maximum likelihood method, a simplified acquisition function is used:

a(x|Dₜ₋₁)=I(y; f|Dₜ₋₁, x, y)∝σₜ₋₁²(x|γ)

wherein σₜ₋₁(x|γ) is a predicted variance of the modeled Gaussian process f|Dₜ₋₁ with the parameters γ.

The method provides that the Gaussian process f is defined by parameters γ defining a mean dependent on the first variable x and a covariance dependent on the first variable x.

The method is performed in the example in iterations t for active learning of the parameters γ.

In a step 200, a first data set is provided in which a value yₜ of the second variable y is respectively assigned to each value xₜ of the first variable x.

In a first iteration t=0, in the example, the initial data set D₀ is provided as the first data set. In further iterations, starting from a data set Dₜ of a previous iteration, a second data set Dₜ₊₁ is determined, in which a determined value xₜ₊₁ of the first variable x as described below and determined value yₜ₊₁ of the second variable y as described below are assigned to each other. With the data set D₀, a data set D₁ is determined in the example.

In the iterations, a current data set Dₜ is used, i.e. in the first iteration the first data set D₀ and then the respectively subsequent second data sets Dₜ₊₁.

Subsequently, a step 202 is performed.

Step 202 is described for a first Gaussian process f₁ and a second Gaussian process f₂ of the plurality I=2 of Gaussian processes fᵢ, i=1,2. For further Gaussian processes fᵢ, one proceeds accordingly.

The first Gaussian process f₁ is configured to map the first variable x onto a first prediction f₁(x) for the second variable Y.

The second Gaussian process f₂ is configured to map the first variable x onto a second prediction f₂(x) for the second variable y. In the example, in step 202, sub-domains of a domain of the modeled Gaussian process f are determined depending on a numerical representation of the binary tree with leaves and nodes

Nᵢ.

A first leaf of the leaves is assigned to the first Gaussian process f₁.

The second Gaussian process f₂ is assigned a second leaf of the leaves different from the first leaf.

The nodes Nᵢ are each assigned a vector wᵢ representing one of the sub-domains.

The nodes Nᵢ are each assigned a first weight σ(wᵢ^{T}\tilde{x}), which is dependent on the first variable x and the vector wᵢ assigned to the respective node Nᵢ.

The nodes Nᵢ are each assigned a second weight 1−σ(wᵢ^{T}\tilde{x}), which is dependent on the first variable x and the vector wᵢ assigned to the respective node Nᵢ.

Subsequently, a step 204 is performed.

In step 204, per node Nᵢ, a pair of the first weight function λ₁ and the first weight σ(wᵢ^{T}\tilde{x}) assigned to this node Nᵢ is assigned a first value, one in the example, if the first weight function

γ₁ is located in the left subtree of the node N_{1.}

In step 204, per node Nᵢ, a pair of the first weight function γ₁ and the first weight σ(wᵢ^{T}\tilde{x}) assigned to this node Nᵢ is assigned a second value, zero in the example, if the first weight function λ₁ is located in the right subtree of the node

In step 204, per node Nᵢ, a pair of the first weight function γ₁ and the second weight 1−σ(wᵢ^{T}\tilde{x}) assigned to this node Nᵢ is assigned the second value, zero in the example, if the first weight function γ₁ is located in the right subtree of the node

In step 204, per node Nᵢ, a pair of first weight function γ₁ and the second weight 1−σ(wᵢ^{T}\tilde{x}) assigned to this node Nᵢ is assigned the first value, one in the example, if the first weight function γ₁ is located in the right subtree of the node

This assignment is encoded in the functions ϑ_{L}(j, i), ϑ_{R}(j, i) in the example.

It can be provided that, per node Nᵢ, the second weight 1−σ(wᵢ^{T}\tilde{x}) is determined depending on the first weight σ(wᵢ^{T}\tilde{x})assigned to this node Nᵢ.

Subsequently, a step 206 is performed.

In step 206, the first weight function λ₁ is determined depending on the first weights σ(wᵢ^{T}\tilde{x}) of the nodes (Nᵢ) in the left subtree of which the first leaf is located.

In step 206, the first weight function λ₁ is determined depending on the second weights 1−σ(wᵢ^{T}\tilde{x}) of the nodes Nᵢ in the right subtree of which the first leaf is located.

In step 206, the second weight function λ₂ is determined depending on the first weights σ(wᵢ^{T}\tilde{x}) of the nodes Nᵢ in the left subtree of which the second of the leaves is located.

In step 206, the second weight function λ₂ is determined depending on the second weights 1−σ(wᵢ^{T}\tilde{x}) of the nodes Nᵢ in the right subtree of which the second leaf is located.

For example, the first weight function λ₁ is determined depending on a computing operation with the first weights σ(wᵢ^{T}\tilde{x}) to which the first value is assigned.

For example, the first weight function λ₁ is determined depending on a computing operation with the first weights 1−σ(wᵢ^{T}\tilde{x}) to which the second value is assigned.

A mapping of the computing operation is determined in the example depending on the values of the functions ϑ_{L}(j, i), ϑ_{R}(j, i). For the first weight function γ₁ and the second weight function γ₂:

$${λ}_{1} ( x ) = {\prod }_{i = 1}^{M} {σ ( {w}_{i}^{T} \tilde{x} )}^{{ϑ}_{L} ( 1 , i )} ( {( 1 - σ ( {w}_{i}^{T} \tilde{x} ) )}^{{ϑ}_{R} ( 1 , i )}$$

$${λ}_{2} ( x ) = {\prod }_{i = 1}^{M} {σ ( {w}_{i}^{T} \tilde{x} )}^{{ϑ}_{L} ( 2 , i )} ( {( 1 - σ ( {w}_{i}^{T} \tilde{x} ) )}^{{ϑ}_{R} ( 2 , i )}$$

It may be provided that the same procedures apply for other weight functions λᵢ.

Subsequently, a step 208 is performed.

At step 208, the Gaussian process f is determined.

For example, the Gaussian process f is determined with the second Gaussian process f₂ depending on the sum Σⱼ₌₁²λⱼ(x)fⱼ(x) of the first Gaussian process f₁ weighted with a first weight function λ₁. In the example, the second Gaussian process f₂ is weighted with the second weight function λ₂.

To determine the sum, it may be provided that a first product of the first weight function λ₁ is determined with a, in particular stationary, first covariance k₁(x, y) of the first Gaussian process f₁.

To determine the sum, it may be provided that a second product of the second weight function λ₁ is determined with a, in particular stationary, second covariance k₂(x, y) of the second Gaussian process f₂.

For example, the sum is determined depending on the result of an addition of the first product with the second product.

Generally, the Gaussian process f is determined with the sum over the plurality of the Gaussian processes fᵢ for which a weight function λᵢ is determined, respectively, as described for the first weight function λ₁:

$${\sum }_{j = 1}^{J} {λ}_{j} ( x ) {f}_{j} ( x )$$

Subsequently, a step 210 is performed.

In step 210, the first variable x is mapped using a Gaussian process f˜GP(μ(x), k(x, x′) onto the prediction f(x) for the second variable y.

Subsequently, a step 212 is performed.

In step 212 at least one of the parameters γ of the Gaussian process f is determined depending on the values from the current data set Dₜ.

For example, the hybrid Monte Carlo algorithm is used as described above. A different method for determining the parameters γ may also be provided, for example an optimization of a loss function, in particular a negative marginal likelihood defined depending on the parameter values of the parameters γ.

Subsequently, a step 214 is performed.

In step 214, with the measure of information gain I, defined depending on the Gaussian process f, the parameter γ, and the respective current data set Dₜ of the iteration, a value xₜ₊₁ of the first variable x is determined. In the example, a value xₜ₊₁ is determined for which the measure I is greater than the measure I for a different value x′ₜ₊₁ of the first variable x. For example, the value xₜ₊₁ is determined that results in the largest measure I:

argmax_{x∈X}I(y; f, γ|D_{t, x})

The measure of information gain I for the value xₜ₊₁ of the first variable x is defined depending on the prediction f(xₜ₊₁) for this first variable xₜ₊₁.

Subsequently, a step 216 is performed.

In step 216, the technical system 102 in one example is operated as a function of the prediction f(xₜ₊₁). In another example, the technical system 102 is operated as a function of the value of the first variable xₜ₊₁ for which the measure for the information gain I indicates a greater information gain than the other value x′ₜ₊₁ of the first variable x. With the technical system 102, a value yₜ₊₁ of the second variable y is determined in the example.

In the example, the value yₜ₊₁ of the second variable y is measured.

It may be provided that the value yₜ₊₁ of the second variable y in active learning is determined using a model of the technical system 102.

Subsequently, a step 202 is performed.

For example, the iterations end after a predetermined time or after a predetermined number of iterations.

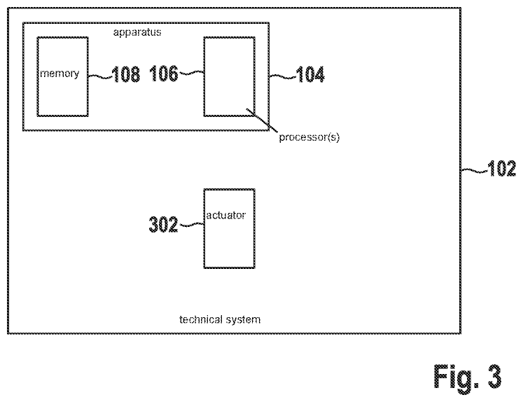

In FIG. 3, a first embodiment of the system 102 is shown schematically.

In the first embodiment, the system 102 includes the apparatus 104 and an actuator 302 configured to operate the system 102 as a function of the first variable x.

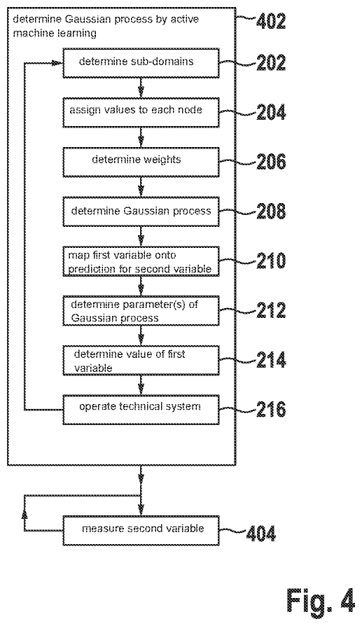

A method of operating a technical system 102 according to the first embodiment is shown in FIG. 4. The technical system 102 is a computer-controlled machine, in particular a robot, preferably a vehicle, a household appliance, a tool powered electrically, pneumatically, hydraulically, or by an internal combustion engine, a manufacturing machine, a personal assistance system, or a locking system.

In a step 402, the Gaussian process f is determined by active machine learning. In the example, steps 202 to 216 are performed to determine the Gaussian process f. In the example, depending on the first variable x, a target variable is determined for the actuator 302 of the technical system 102. The target variable is output to control the actuator 302 of the technical system 102. For example, the variable x, for which the Gaussian process f makes a prediction f(x), is determined and output, which results in a desired behavior of the second variable y.

Subsequently, a step 404 is performed.

In step 404, the second variable y is measured on the technical system 102.

For example, the second variable y includes data of a sensor signal from a sensor provided on the technical system 102 and which in operation of the technical system 102 captures information concerning a state of the technical system 102.

Subsequently, the step 404 is performed.

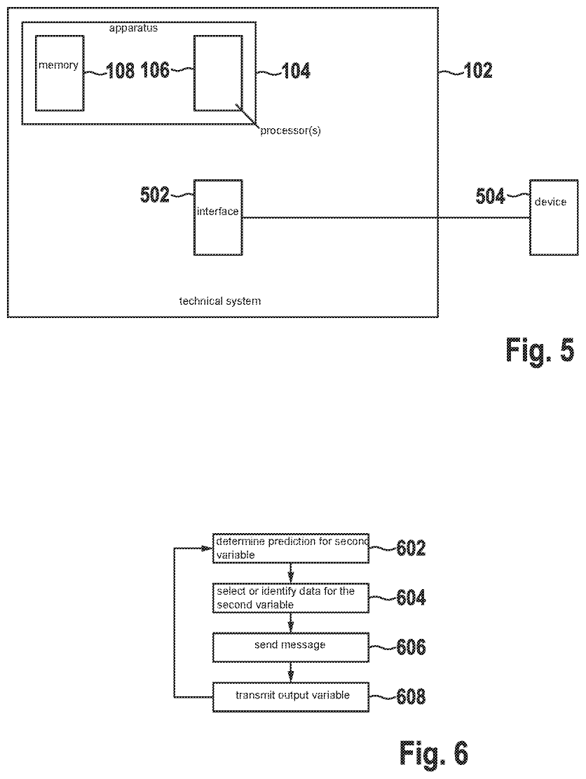

In FIG. 5, a second embodiment of the system 102 is shown schematically.

In the second embodiment, the technical system 102 includes the apparatus 104 and an interface 502 configured to send the message from the technical system 102 to a device 504 arranged in particular at a distance from the technical system 102.

A method of operating a technical system 102 according to the second embodiment is shown in FIG. 6.

In a step 602, depending on a first variable x, the prediction f(x) for the second variable y is determined using the Gaussian process f.

In the example, the first variable x is a variable adjustable on the remotely arranged device, e.g., on the test bench. For example, the second variable y includes data of a sensor signal from a sensor, which is provided at the remotely situated device 504 and which in operation of this device 504 captures information concerning a state of the device 504.

For example, the device 504 is a test bench, particularly for a motor. In this example, the data includes an output variable of the test bench.

For example, in a step 604, depending on the prediction f(x), data are identified or selected for the second variable y. In the example, the data are identified that are to be transmitted by the remote device 504. It may be provided that the data are identified that are to be captured by the device 504. It may be provided that the data are identified that are to be determined by the device 504.

In a step 606, a message is sent from the technical system 102 to the device 504 situated in particular at a distance from the technical system 102.

The message includes, for example, an in particular alphanumeric identification of the data or instructs the device 504 to capture or determine the data and/or to transfer the data.

For example, the technical system 102 sends an instruction for the test bench to the test bench that instructs the test bench to capture the output variable of the test bench, in particular with a sensor.

The device 504 operates as instructed. In the example, the output variable of the test bench is determined by operating the test bench.

In a step 608, the output variable transmitted by the device 504 is received by the technical system 102.

Subsequently, step 602 is performed.

The first variable x, e.g., the control variable of the test bench, is transmitted from the device 504 to the technical system 102.

The device 504 may also be a computing device, in particular for the computer-based simulation of fluid dynamics. In this case, the second variable y is, for example, an output variable of the simulation determined by the simulation.

In this case, in step 604, depending on the prediction f(x) for the second variable y, data are identified or selected which are to be determined by the simulation as output variable.

In this example, in step 606, the technical system 102 sends an instruction for the simulation to the computing device that instructs the computing device to determine the output variable of the simulation by the simulation.

It may be provided that an input variable for the simulation is identified or indicated in the instruction. It may also be provided to determine the input variable depending on the prediction f(x).

For example, the Gaussian process f for determining the prediction f(x) by which the data are identified or selected is determined prior to method step 602 as described in steps 202 to 216.

What is claimed is:

1. A computer-implemented method of operating a technical system, comprising:
mapping a first variable of the technical system onto a prediction for a second variable of the technical system using a Gaussian process; and
operating the technical system as a function of the prediction or as a function of a value of the first variable, for which a measure for the information gain, defined as a function of the prediction, indicates a greater information gain than for a different value of the first variable;
wherein the Gaussian process, depending on a sum of a first Gaussian process which is weighted with a first weight function, is determined with a second Gaussian process,
wherein the first Gaussian process is configured to map the first variable onto a first prediction for the second variable, and the second Gaussian process is configured to map the first variable onto a second prediction for the second variable,
wherein sub-domains of a domain and/or a value range of the Gaussian process are determined depending on a numerical representation of a binary tree with leaves and nodes,
wherein a first leaf of the leaves is assigned to the first Gaussian process,
wherein the nodes are each assigned a vector representing one of the sub-domains,
wherein the nodes are each assigned a first weight that depends on the first variable and the vector assigned to the respective node, and the first weight function is determined depending on the first weights of the nodes in a left subtree of which the first leaf is located, and/or each of the nodes is assigned a second weight, depending on the first variable and the vector assigned to the node, wherein the first weight function is determined depending on the second weights of the nodes in a right subtree of which the first leaf is located.

2. The method as recited in claim 1, wherein the second Gaussian process is weighted with a second weight function, wherein the second Gaussian process is assigned a second leaf of the leaves that is different from the first leaf, wherein: (i) the second weight function is determined depending on the first weights of the nodes in the left subtree of which the second of the leaves is located, and/or (ii) the second weight function is determined depending on the second weights of the nodes in the right subtree of which the second leaf is located.

3. The method as recited in claim 1, wherein, for each node, the second weight is determined depending on the first weight assigned to the node.

4. The method as recited in claim 1, wherein: (i) for each node, a first value is assigned to a pair of the first weight function and the first weight assigned to the node, when the first weight function is located in the left subtree of the node, and the first weight function is determined depending on a computing operation with the first weight and the first value, and/or (ii) for each node, a second value is assigned to a pair of the first weight function and the first weight assigned to the node, when the first weight function is located in the subtree of the node, and the first weight function is determined depending on a computing operation with the first weight and the second value.

5. The method as recited in claim 1, wherein: (i) for each node, a first value is assigned to a pair of the first weight function and the second weight assigned to the node, when the first weight function is located in the right subtree of the node, and the first weight function is determined depending on a computing operation with the first weight and the first value, and/or, (ii) for each node, a second value is assigned to a pair of the first weight function and the second weight assigned to the node, when the first weight function is located in the left subtree of the node, and the first weight function is determined depending on a computing operation with the first weight and the second value.

6. The method as recited in claim 1, wherein, to determine the sum, a first product of the first weight function is determined with a stationary first covariance of the first Gaussian process, a second product of the second weight function is determined with a stationary second covariance of the second Gaussian process, and the sum is determined depending on a result of an addition of the first product with the second product.

7. The method as recited in claim 1, wherein the Gaussian process is defined by parameters that define a mean value dependent on the first variable and a covariance dependent on the first variable, wherein a first data set is provided in which a value of the second variable is respectively assigned to a value of the first variable, wherein at least one of the parameters of the Gaussian process is determined depending on values from the first data set.

8. The method as recited in claim 7, wherein the measure of the information gain is defined dependent on the Gaussian process, the parameter, and the first data set, wherein the value of the first variable is determined, for which the measure is greater than the measure of the other value of the first variable, wherein a value of the second variable is determined with the technical system or with a model of the technical system, wherein a second data set is determined, in which the determined value of the first variable and the determined value of the second variable are assigned to each other. and wherein at least one of the parameters of the Gaussian process is determined depending on values from the second data set.

9. The method as recited in claim 8, wherein the measure of the information gain is defined depending on the first weight function and the second weight function such that the measure of information gain has a higher value where the weight function of the Gaussian process having a higher individual information content is higher.

10. The method as recited in claim 1, wherein the first variable is a target variable for an actuator of the technical system or a target variable for an actuator of the technical system is determined depending on the first variable, wherein the technical system is a computer controlled machine, the computer controlled machine including: (i) a robot, or (ii) a vehicle, or (iii) a household appliance, or (iv) a tool powered electrically or pneumatically or hydraulically or by an internal combustion engine, or (v) a fabrication machine, or (vi) a personal assistance system, or (vii) a locking system.

11. The method as recited in claim 1, wherein the prediction for the second variable identifies data or the data are selected depending on the prediction for the second variable, wherein a message is transmitted from the technical system to a device arranged at a distance from the technical system, which comprises an identification of the data or which instructs the device to acquire or determine the data and/or transfer the data.

12. The method as recited in claim 11, wherein the device is a test bench for a motor, wherein the data includes an output variable of the test bench, and an instruction for the test bench is sent from the technical system to the test bench instructing the test bench to capture the output variable of the test bench with a sensor.

13. The method as recited in claim 11, wherein the device is a computing device for a computer-based simulation of fluid dynamics, wherein the data includes an output variable of the simulation, and an instruction for the simulation is sent from the technical system to the computing device, which instructs the computing device to determine the output variable of the simulation by the simulation depending on an input variable identified or specified in the instruction.

14. An apparatus for operating a system, comprising:
at least one processor; and
at least one memory;
wherein the apparatus is configured to operate a technical system, the apparatus configured to:
map a first variable of the technical system onto a prediction for a second variable of the technical system using a Gaussian process, and
operate the technical system as a function of the prediction or as a function of a value of the first variable, for which a measure for the information gain, defined as a function of the prediction, indicates a greater information gain than for a different value of the first variable,
wherein the Gaussian process, depending on a sum of a first Gaussian process which is weighted with a first weight function, is determined with a second Gaussian process,
wherein the first Gaussian process is configured to map the first variable onto a first prediction for the second variable, and the second Gaussian process is configured to map the first variable onto a second prediction for the second variable,
wherein sub-domains of a domain and/or a value range of the Gaussian process are determined depending on a numerical representation of a binary tree with leaves and nodes,
wherein a first leaf of the leaves is assigned to the first Gaussian process,
wherein the nodes are each assigned a vector representing one of the sub-domains,
wherein the nodes are each assigned a first weight that depends on the first variable and the vector assigned to the respective node, and the first weight function is determined depending on the first weights of the nodes in a left subtree of which the first leaf is located, and/or each of the nodes is assigned a second weight, depending on the first variable and the vector assigned to the node, wherein the first weight function is determined depending on the second weights of the nodes in a right subtree of which the first leaf is located.

15. A system, comprising:
apparatus configured to:
map a first variable of the system onto a prediction for a second variable of the system using a Gaussian process;
wherein the Gaussian process, depending on a sum of a first Gaussian process which is weighted with a first weight function, is determined with a second Gaussian process,
wherein the first Gaussian process is configured to map the first variable onto a first prediction for the second variable, and the second Gaussian process is configured to map the first variable onto a second prediction for the second variable,
wherein sub-domains of a domain and/or a value range of the Gaussian process are determined depending on a numerical representation of a binary tree with leaves and nodes,
wherein a first leaf of the leaves is assigned to the first Gaussian process,
wherein the nodes are each assigned a vector representing one of the sub-domains,
wherein the nodes are each assigned a first weight that depends on the first variable and the vector assigned to the respective node, and the first weight function is determined depending on the first weights of the nodes in a left subtree of which the first leaf is located, and/or each of the nodes is assigned a second weight, depending on the first variable and the vector assigned to the node, wherein the first weight function is determined depending on the second weights of the nodes in a right subtree of which the first leaf is located; and
an actuator configured to operate the system as a function of the prediction.

16. A system, comprising:
an apparatus for operating a technical system, including:
at least one processor; and
at least one memory;
wherein the apparatus is configured to operate a technical system, the apparatus configured to:
map a first variable of the technical system onto a prediction for a second variable of the technical system using a Gaussian process, and
operate the technical system as a function of the prediction or as a function of a value of the first variable, for which a measure for the information gain, defined as a function of the prediction, indicates a greater information gain than for a different value of the first variable,
wherein the Gaussian process, depending on a sum of a first Gaussian process which is weighted with a first weight function, is determined with a second Gaussian process,
wherein the first Gaussian process is configured to map the first variable onto a first prediction for the second variable, and the second Gaussian process is configured to map the first variable onto a second prediction for the second variable,
wherein sub-domains of a domain and/or a value range of the Gaussian process are determined depending on a numerical representation of a binary tree with leaves and nodes,
wherein a first leaf of the leaves is assigned to the first Gaussian process,
wherein the nodes are each assigned a vector representing one of the sub-domains,
wherein the nodes are each assigned a first weight that depends on the first variable and the vector assigned to the respective node, and the first weight function is determined depending on the first weights of the nodes in a left subtree of which the first leaf is located, and/or each of the nodes is assigned a second weight, depending on the first variable and the vector assigned to the node, wherein the first weight function is determined depending on the second weights of the nodes in a right subtree of which the first leaf is located;
wherein the prediction for the second variable identifies data or the data are selected depending on the prediction for the second variable, wherein a message is transmitted from the technical system to a device arranged at a distance from the technical system, which includes an identification of the data or which instructs the device to acquire or determine the data and/or transfer the data,
wherein the device is a computing device for a computer-based simulation of fluid dynamics, wherein the data includes an output variable of the simulation, and an instruction for the simulation is sent from the technical system to the computing device, which instructs the computing device to determine the output variable of the simulation by the simulation depending on an input variable identified or specified in the instruction; and
an interface configured to send the message from the system to the device.
